(19) United States
(12) Patent Application Publication
(10) Pub. No.: US 2020/0175922 A1
(43) Pub. Date: Jun. 4, 2020

(54) PIXEL DRIVING CIRCUIT, DRIVING METHOD AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventor: Zheng WANG, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 16/551,168

(22) Filed: Aug. 26, 2019

(30) Foreign Application Priority Data
Nov. 29, 2018 (CN) 201811446577.X

(51) Int. Cl. G09G 3/3258; G09G 3/3233

(52) U.S. Cl. CPC G09G 3/3258; G09G 2310/0264; G09G 3/3233

(57) ABSTRACT

The present disclosure provides a pixel driving circuit, a driving method and a display device for driving the light emitting device in a pixel. The pixel driving circuit includes a reset sub-circuit, a storage sub-circuit, a compensation sub-circuit, a data writing sub-circuit and a driving transistor. The compensation sub-circuit is configured to write a threshold voltage of the driving transistor to the second node according to a fourth voltage input from the fourth voltage input terminal. The data writing sub-circuit is configured to write a sixth voltage input from the sixth voltage input terminal to the first node according to a fifth voltage input from the fifth voltage input terminal. The driving transistor is configured to drive the organic light emitting diode to emit light according to a voltage of the second node.

### CROSS-REFERENCE TO RELATED APPLICATION

This application claims priority to Chinese Patent Application No. 201811446577.X filed on Nov. 29, 2018, which is incorporated herein by reference in its entirety.

### TECHNICAL FIELD

The present disclosure relates to a field of a display technology, in particular to a pixel driving circuit, a driving method and a display device.

### BACKGROUND

An Active Matrix Organic Light Emitting Diode (AMOLED) display panel uses OLEDs to emit light with different brightness, so that a pixel display corresponding to the OLED has corresponding brightness. Compared to a conventional thin film transistor liquid crystal display panel, the AMOLED display panel has faster response speed, higher contrast and broader perspective, and becomes an important growing branch of display panel.

A driving current for driving an OLED to emit light is related to a threshold voltage Vth of a driving transistor. However, the threshold voltage Vth of the driving transistor may drift during a light-emitting stage, which may affect brightness of the OLED, make it non-uniformed in a light-emitting process, and produce adverse effect on display and life of an OLED display panel.

### SUMMARY

The present disclosure provides a pixel driving circuit for driving a light emitting device in a pixel, including a reset sub-circuit, a storage sub-circuit, a compensation sub-circuit, a data writing sub-circuit and a driving transistor;

the reset sub-circuit is connected with a first voltage input terminal, a second voltage input terminal, a third voltage input terminal, a first node and a second node respectively and is configured to write a first voltage input from the first voltage input terminal to the first node, and write a second voltage input from the second voltage input terminal to the second node according to a third voltage input from the third voltage input terminal;

the storage sub-circuit is connected with the first node and the second node respectively and is configured to store a voltage on a control electrode of the driving transistor;

the compensation sub-circuit is connected with a fourth voltage input terminal, the second node and an anode of the light emitting device respectively and is configured to write a threshold voltage of the driving transistor to the second node according to a fourth voltage input from the fourth voltage input terminal;

the data writing sub-circuit is connected with a fifth voltage input terminal, a sixth voltage input terminal and the first node respectively and is configured to write a sixth voltage input from the sixth voltage input terminal to the first node according to a fifth voltage input from the fifth voltage input terminal; and

a control electrode of the driving transistor is connected with the second node, a first electrode of the driving transistor is connected with the first voltage input terminal, and a second electrode of the driving transistor is connected with the anode of the light emitting device, to drive the light emitting device to emit light according to a voltage of the second node.

Optionally, the reset circuit includes a first transistor and a second transistor;

a control electrode of the first transistor is connected with the third voltage input terminal, a first electrode of the first transistor is connected with the first voltage input terminal, and a second electrode of the first transistor is connected with the first node;

a control electrode of the second transistor is connected with the third voltage input terminal, a first electrode of the second transistor is connected with the second voltage input terminal, and a second electrode of the second transistor is connected with the second node.

Optionally, the storage sub-circuit includes a storage capacitor, a first end of the storage capacitor is connected with the first node, and a second end of the storage capacitor is connected with the second node.

Optionally, the compensation sub-circuit includes a third transistor, a control electrode of the third transistor is connected with the fourth voltage input terminal, a first electrode of the third transistor is connected with the second node, and a second electrode of the third transistor is connected with the anode of the light emitting device.

Optionally, the data writing sub-circuit includes a fourth transistor, a control electrode of the fourth transistor is connected with the fifth voltage input terminal, a first electrode of the fourth transistor is connected with the sixth voltage input terminal, and a second electrode of the fourth transistor is connected with the first node.

Optionally, the active layer of the driving transistor is made of amorphous silicon.

Optionally, the pixel driving circuit further including a fifth transistor, a control electrode of the fifth transistor is connected with the fourth voltage input terminal, a first electrode of the fifth transistor is connected with the first voltage input terminal, and a second electrode of the fifth transistor is connected with the first node.

Optionally, the reset circuit includes a first transistor and a second transistor; a control electrode of the first transistor is connected with the third voltage input terminal, a first electrode of the first transistor is connected with the first voltage input terminal, and a second electrode of the first transistor is connected with the first node; a control electrode of the second transistor is connected with the third voltage input terminal, a first electrode of the second transistor is connected with the second voltage input terminal, and a second electrode of the second transistor is connected with the second node;

the storage sub-circuit includes a storage capacitor, a first end of the storage capacitor is connected with the first node, and a second end of the storage capacitor is connected with the second node;

the compensation sub-circuit includes a third transistor, a control electrode of the third transistor is connected with the fourth voltage input terminal, a first electrode of the third transistor is connected with the second node, and a second electrode of the third transistor is connected with the anode of the light emitting device;

the data writing sub-circuit includes a fourth transistor, a control electrode of the fourth transistor is connected with the fifth voltage input terminal, a first electrode of the fourth transistor is connected with the sixth voltage input terminal, and a second electrode of the fourth transistor is connected with the first node; and

the pixel driving circuit further includes a fifth transistor, a control electrode of the fifth transistor is connected with the fourth voltage input terminal, a first electrode of the fifth transistor is connected with the first voltage input terminal, and a second electrode of the fifth transistor is connected with the first node.

The present disclosure provides a display device, including the pixel driving circuit described in any embodiment.

The present disclosure provides a pixel driving method applied to the pixel driving circuit described in any embodiment, including:

in a reset stage, writing the first voltage to the first node, and writing the second voltage to the second node according to the third voltage; wherein the first voltage input terminal is supplied with the first voltage, the second voltage input terminal is supplied with the second voltage, and the third voltage input terminal is supplied with the third voltage;

in a compensation stage, writing the threshold voltage of the driving transistor to the second node according to the fourth voltage, wherein the fourth voltage input terminal is supplied with the fourth voltage; and

in a light-emitting stage, writing the sixth voltage to the first node according to the fifth voltage, and driving the light emitting device to emit light according to the voltage of the second node, wherein the fifth voltage input terminal is supplied with the fifth voltage, the sixth voltage input terminal is supplied with the sixth voltage.

Optionally, in the reset stage, the first voltage is low level, the second voltage is high level, and the sixth voltage is low level;

in the compensation stage, the first voltage is low level, the second voltage is high level, and the sixth voltage is low level; and

in the light-emitting stage, the first voltage is high level, the second voltage is low level, and the sixth voltage is high level.

Optionally, the transistors included in the reset sub-circuit, the compensation sub-circuit, and the data writing sub-circuit and the driving transistor are all N-type transistors,

in the reset stage, the third voltage is high level, the fourth voltage is low level, and the fifth voltage is low level;

in the compensation stage, the third voltage is low level, the fourth voltage is high level, and the fifth voltage is low level;

in the light-emitting stage, the third voltage is low level, the fourth voltage is low level, and the fifth voltage is high level.

### BRIEF DESCRIPTION OF THE DRAWINGS

In order to more clearly illustrate the technical solutions according to the embodiments of the present disclosure, the drawings used in the description of the embodiments will be briefly introduced below. Apparently, the drawings used in the description below illustrate only partial embodiments of the present disclosure, and other drawings may be obtained by one of ordinary skills in the art in light of these described drawings without creative work.

FIG. 1 is a schematic diagram illustrating the structure of a pixel driving circuit according to the related art;

FIG. 2 is a schematic diagram illustrating the structure of a pixel driving circuit according to some embodiments of the present disclosure;

FIG. 3 is a timing diagram of each input signal of a pixel driving circuit within a light-emitting period according to some embodiments of the present disclosure;

FIG. 4 is a schematic diagram illustrating the equivalent structure of a pixel driving circuit in a reset stage according to some embodiments of the present disclosure;

FIG. 5 is a schematic diagram illustrating the equivalent structure of a pixel driving circuit in a compensation stage according to some embodiments of the present disclosure;

FIG. 6 is a schematic diagram illustrating the equivalent structure of a pixel driving circuit in a light-emitting according to some embodiments of the present disclosure;

FIG. 7 is a schematic flow chart showing a driving method according to some embodiments of the present disclosure.

### DETAILED DESCRIPTION

In order to make the object, technical solution and merits of the present disclosure clearer, the present disclosure will be illustrated in detail hereinafter with reference to the accompanying drawings.

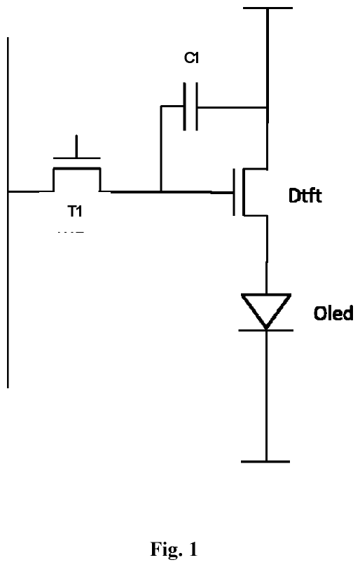

A conventional OLED pixel driving circuit structure is 2T1C structure. Referring to FIG. 1, a transistor Dtft (driver TFT) is a driving transistor. A transistor T1 is provided to write a signal on a data line onto a capacitor C1 and store it to control a gate voltage of the transistor Dtft, and then control a current of an OLED. The driving current of the OLED may be expressed by the following formula:

$${I}_{OLED} = \frac{β}{2} ( Vgs - Vth ) ;$$

Wherein, Vgs is a voltage difference between a gate and a source of the driving transistor, β is a parameter related to process parameters and characteristic sizes of the driving transistor, and Vth is a threshold voltage of the driving transistor.

According to the formula, the driving current of the OLED is related to the threshold voltage Vth of the driving transistor. In a practical application, it is found that a large duty cycle of the driving transistor may cause the threshold voltage Vth of the driving transistor to drift during a light-emitting stage, which may affect brightness of the OLED, make it non-uniformed in a light-emitting process, and produce adverse effect on display and life of an OLED display panel.

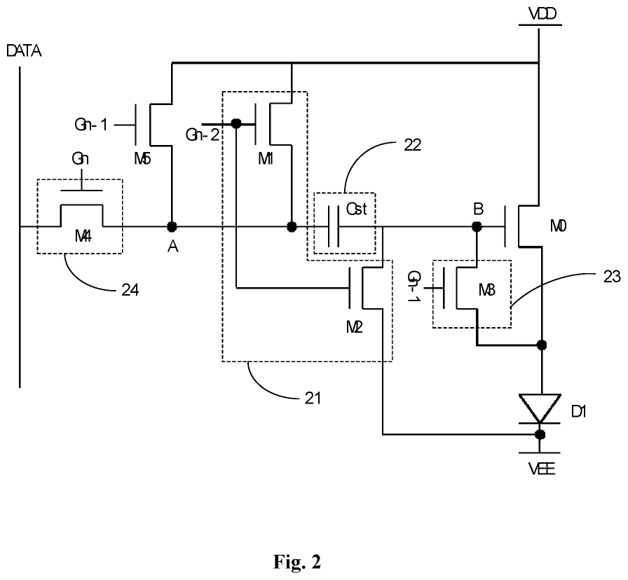

In order to solve above problems, some embodiments of the present disclosure provide an OLED pixel driving circuit for driving a light emitting device D1 in an OLED pixel to emit light, referring to FIG. 2, the OLED pixel driving circuit includes a reset sub-circuit 21, a storage sub-circuit 22, a compensation sub-circuit 23, a data writing sub-circuit 24 and a driving transistor M0.

Specifically, the reset sub-circuit 21 is connected with a first voltage input terminal VDD, a second voltage input terminal VEE, a third voltage input terminal Gn-2, a first node A and a second node B respectively, so as to write a first voltage input from the first voltage input terminal VDD to the first node A, and write a second voltage input from the second voltage input terminal VEE to the second node B according to a third voltage input from the third voltage input terminal Gn-2.

The storage sub-circuit 22 is connected with the first node A and the second node B respectively and is configured to store a voltage on a control electrode of the driving transistor M0.

The compensation sub-circuit 23 is connected with a fourth voltage input terminal Gn-1, the second node B and an anode of the light emitting device respectively and is configured to write a threshold voltage of the driving transistor M0 to the second node B according to a fourth voltage input from the fourth voltage input terminal Gn-1.

The data writing sub-circuit 24 is connected with a fifth voltage input terminal Gn, a sixth voltage input terminal DATA and the first node A respectively and is configured to write a sixth voltage input from the sixth voltage input terminal DATA to the first node A according to a fifth voltage input from the fifth voltage input terminal Gn.

A control electrode of the driving transistor M0 is connected with the second node B, a first electrode of the driving transistor M0 is connected with the first voltage input terminal VDD, and a second electrode thereof is connected with the anode of the light emitting device, to drive the light emitting device D1 to emit light according to a voltage of the second node B.

In each transistor of the embodiment, the control electrode may be a gate electrode, the first electrode may be a source electrode, and the second electrode may be a drain electrode; of course, the first electrode may also be a drain electrode while the second electrode may be a source electrode.

When the OLED pixel driving circuit provided in the embodiment drives the light emitting device D1 in the OLED pixel to emit light, in a reset stage, the first voltage is input to the first voltage input terminal VDD, the second voltage is input to the second voltage input terminal VEE, and the third voltage is input to the third voltage input terminal Gn-2, the reset sub-circuit 21 writes the first voltage to the first node A, and writes the second voltage to the second node B according to the third voltage. In the reset stage, a voltage of the first node A is VDD, and a voltage of the second node B is VEE.

In a compensation stage, the fourth voltage is input to the fourth voltage input terminal Gn-1, the compensation sub-circuit 23 writes the threshold voltage Vth of the driving transistor M0 to the second node B according to the fourth voltage. Specifically, in the compensation stage, the compensation sub-circuit 23 may turn on the control electrode and the second electrode of the driving transistor M0 according to the fourth voltage. At this time, the driving transistor M0 is connected to be a diode. The second node B discharges to the first voltage input terminal VDD until the voltage of the second node B is VDD+Vth. At this stage, the voltage of the first node A is still VDD.

In a light-emitting stage, the fifth voltage is input to the fifth voltage input terminal Gn, the sixth voltage Vdata is input to the sixth voltage input terminal DATA, and the sixth voltage Vdata is written to the first node A according to the fifth voltage. And the pixel driving circuit drives the light emitting device to emit light according to the voltage of the second node B. In the light-emitting stage, the voltage of the first node A is Vdata, and the voltage of the second node B becomes Vdata+Vth under a coupling effect of the storage sub-circuit 22. The driving current Ioled may be calculated based on driving transistor M0 by the following formula:

$${I}_{OLED} = \frac{β}{2} {( Vgs - Vth )}^{2} = \frac{β}{2} {( Vdata + Vth - VDD - Vth )}^{2} = \frac{β}{2} {( Vdata - VDD )}^{2} ;$$

Thus, the driving current of the OLED is only related to the sixth voltage Vdata and the first voltage VDD, and an influence of the threshold voltage Vth drift of the driving transistor M0 on the driving current Ioled may be eliminated.

The OLED pixel driving circuit provided in the embodiment may write the threshold voltage of the driving transistor into the control electrode of the driving transistor through the compensation sub-circuit, and store the voltage on the control electrode of the driving transistor through the storage sub-circuit. When the driving transistor and the light emitting device are turned on, the generated driving current is independent to the threshold voltage of the driving transistor. Therefore, a phenomenon of uneven picture caused by the drift of the threshold voltage of the driving transistor may be eliminated, a display effect of an OLED display may be improved, and brightness of the OLED may attenuate more slowly, and a life of the product may be prolonged.

Specifically, the reset circuit 21 may include a first transistor M1 and a second transistor M2; a control electrode of the first transistor M1 is connected with the third voltage input terminal Gn-2, a first electrode of the first transistor M1 is connected with the first voltage input terminal VDD, and a second electrode thereof is connected with the first node A; a control electrode of the second transistor M2 is connected with the third voltage input terminal Gn-2, a first electrode of the second transistor M2 is connected with the second voltage input terminal VEE, and a second electrode thereof is connected with the second node B.

The storage sub-circuit 22 may include a storage capacitor Cst, a first end of the storage capacitor Cst is connected with the first node A, and a second end is connected with the second node B.

The compensation sub-circuit 23 may include a third transistor M3, a control electrode of the third transistor M3 is connected with the fourth voltage input terminal Gn-1, a first electrode of the third transistor M3 is connected with the second node B, and a second electrode of the third transistor M3 is connected with the anode of the light emitting device.

The data writing sub-circuit 24 includes a fourth transistor M4, a control electrode of the fourth transistor M4 is connected with the fifth voltage input terminal Gn, a first electrode of the fourth transistor M4 is connected with the sixth voltage input terminal DATA, and a second electrode of the fourth transistor M4 is connected with the first node A. The sixth voltage input terminal DATA may be a data voltage signal input terminal.

Since a phenomenon of the threshold voltage Vth drift is obvious for a driving transistor M0 fabricated using amorphous silicon process, the active layer material of the driving transistor M0 in the embodiment may be amorphous silicon.

In order to ensure that the voltage of the first node A remains stable during the compensation stage and avoid an influence of the second node B, the OLED pixel driving circuit provided in each embodiment described above may also include a fifth transistor M5. A control electrode of the fifth transistor M5 is connected with the fourth voltage input terminal Gn-1, a first electrode of the fifth transistor M5 is connected with the first voltage input terminal VDD, and a second electrode thereof is connected with the first node A. The fifth transistor M5 may input the first voltage into the first node A according to the fourth voltage.

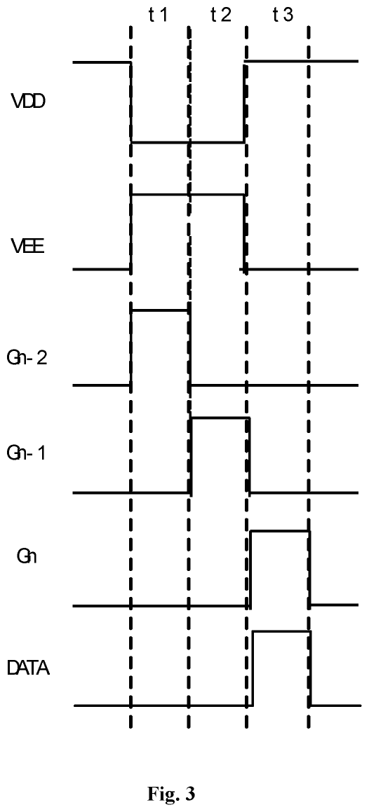

Taking that the first transistor M1, the second transistor M2, the third transistor M3, the fourth transistor M4, the fifth transistor M5 and the driving transistor M0 are all N-type transistors as example, and in combination with the timing diagram of each input signal within a light-emitting period shown in FIG. 3, the process and principle of the OLED pixel driving circuit provided in the embodiment to drive the light emitting device in the OLED pixel to emit light will be described in detail.

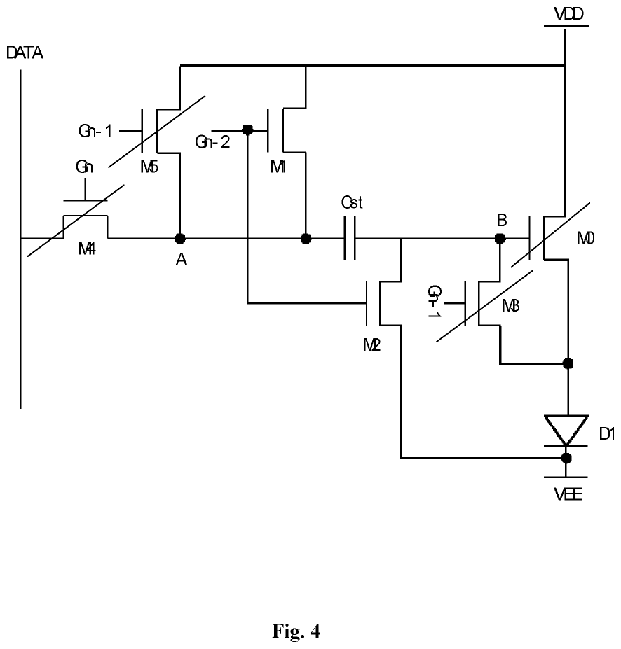

In the reset stage t1, the first voltage VDD is low level, the second voltage is high level. The third voltage Gn-2 is high level, the first transistor M1 and the second transistor M2 are turned on. The voltage of the first end of the storage capacitor Cst (first node A) is VDD, and the voltage of the second end of the storage capacitor Cst (second node B) is Vee. Referring to FIG. 4, FIG. 4 is a schematic diagram illustrating the equivalent structure of a pixel driving circuit in a reset stage.

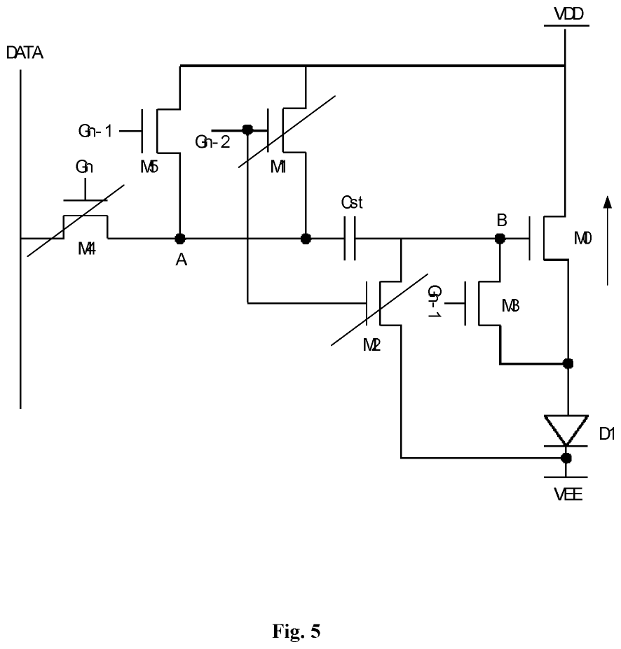

In the compensation stage t2, the third voltage Gn-2 is low level, the first transistor M1 and second transistor M2 are turned off. The fourth voltage Gn-1 is high level, the third transistor M3 is turned on, and the control electrode (the second node B) and the second electrode (anode of the light emitting device) of the driving transistor M0 are turned on. At this time, the driving transistor M0 is connected to be a diode. The second node B discharges to the first voltage input terminal VDD until the voltage of the second node B is VDD+Vth. The control voltage VDD+Vth of the driving transistor M0 is stored on Cst. At the same time, the fifth transistor M5 is turned on to conduct the first voltage input terminal VDD and the first node A, such that the voltage of the first node A is kept stable and avoided from being affected by the voltage of the second node B. Referring to FIG. 5, FIG. 5 is a schematic diagram illustrating the equivalent structure of a pixel driving circuit in a compensation stage.

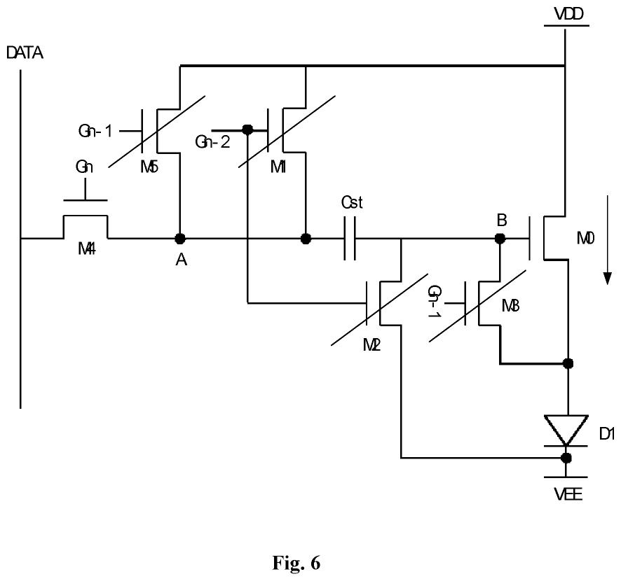

In the light-emitting stage t3, the first voltage VDD changes from low level to high level, and the second voltage VEE changes from high level to low level. Wherein, the fifth voltage Gn is high level, the fourth transistor M4 is turned on, the sixth voltage Vdata of the sixth voltage input terminal is written to the first node A, the voltage of the second node B becomes Vdata+Vth under a coupling effect of the storage capacitor Cst, and the Vdata is high level, so the driving transistor M0 is turned on, and because the second voltage VEE is low level, the light emitting device starts to emit light. Similarly, according to the above formula for driving current, the driving current of the OLED is only related to the sixth voltage Vdata, and an influence of threshold voltage drift of the driving transistor on the driving current may be eliminated. Referring to FIG. 6, FIG. 6 is a schematic diagram illustrating the equivalent structure of a pixel driving circuit in a light-emitting stage.

Therefore, according to the OLED pixel driving circuit provided in the embodiment, an influence of deterioration of the threshold voltage Vth characteristic of the driving transistor on the driving current can be alleviated by providing the 5T1C structure as well as the timing and voltage changing sequences in the circuit. By utilizing the cut-off characteristic of the driving transistor, the threshold voltage Vth is written into the control electrode of the driving transistor. By means of changes of each input signal, such as voltage changes of the first voltage VDD and the second voltage VEE, the circuit is turned on or off, thereby the influence of Vth on driving current may be eliminated and a life of a pixel device may be prolonged.

In addition, the 5T1C structure provided in the embodiments of the present disclosure may adopt any suitable number of transistors, capacitors and control lines, thereby the complexity of manufacturing the pixel driving circuit is reduced.

Other embodiments of the present disclosure also provide a display device including the OLED pixel driving circuit provided by any embodiment.

It should be noted that, the display device in the embodiment may be any product or component with display function, such as display panel, electronic paper, mobile phone, tablet computer, TV set, notebook computer, digital photo frame, navigator, etc.

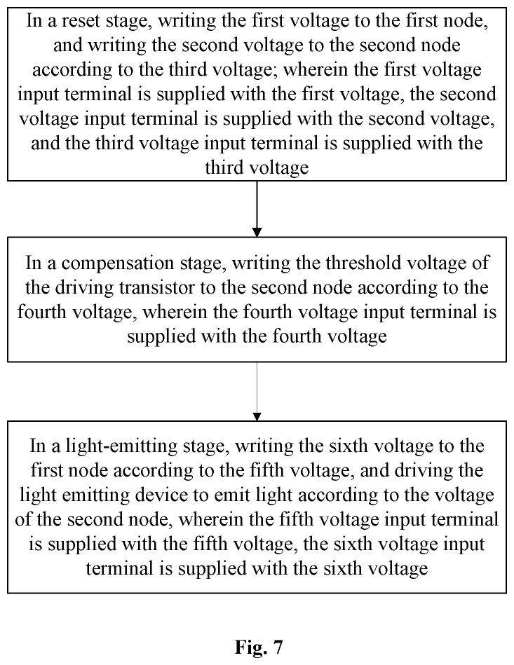

Other embodiments of the present disclosure also provide a pixel driving method applied to the pixel driving circuit provided by any embodiment, as shown in FIG. 7, the pixel driving method may include:

In a reset stage, writing the first voltage to the first node, and writing the second voltage to the second node according to the third voltage; wherein the first voltage is input to the first voltage input terminal, the second voltage is input to the second voltage input terminal, and the third voltage is input to the third voltage input terminal.

Specifically, the stage may be performed by a reset sub-circuit.

In a compensation stage, writing the threshold voltage of the driving transistor to the second node according to the fourth voltage, wherein the fourth voltage is input to the fourth voltage input terminal.

Specifically, the stage may be performed by a compensation sub-circuit.

In a light-emitting stage, writing the sixth voltage to the first node according to the fifth voltage, and driving the light emitting device to emit light according to the voltage of the second node, wherein the fifth voltage is input to the fifth voltage input terminal, the sixth voltage is input to the sixth voltage input terminal.

Specifically, the stage may be performed by a data writing sub-circuit and a driving transistor.

In one way of implementation, in the reset stage, the first voltage is low level, the second voltage is high level, and the sixth voltage is low level.

In the compensation stage, the first voltage is low level, the second voltage is high level, and the sixth voltage is low level.

In the light-emitting stage, the first voltage is high level, the second voltage is low level, and the sixth voltage is high level.

Optionally, the transistors in the reset sub-circuit, the compensation sub-circuit, and the data writing sub-circuit and the driving transistor are all N-type transistors,

In the reset stage, the third voltage is high level, the fourth voltage is low level, and the fifth voltage is low level.

In the compensation stage, the third voltage is low level, the fourth voltage is high level, and the fifth voltage is low level.

In the light-emitting stage, the third voltage is low level, the fourth voltage is low level, and the fifth voltage is high level.

The process and principle of the OLED pixel driving method at each stage in the embodiment may refer to the above-mentioned embodiments, which will not be repeated here.

Some embodiments of the present disclosure provide an OLED pixel driving circuit, a driving method and a display device for driving the light emitting device in an OLED pixel. Wherein, the OLED pixel driving circuit includes a reset sub-circuit, a storage sub-circuit, a compensation sub-circuit, a data writing sub-circuit and a driving transistor. The threshold voltage of the driving transistor is written into the control electrode of the driving transistor by the compensation sub-circuit, and the voltage on the control electrode of the driving transistor is stored by the storage sub-circuit. When the driving transistor and the light emitting device are turned on, the generated driving current is unrelated to the threshold voltage of the driving transistor. Therefore, a phenomenon of uneven picture caused by the drift of the threshold voltage of the driving transistor may be eliminated, a display effect of an OLED display may be improved, and brightness of the OLED may attenuate more slowly, and a life of the product may be prolonged.

Each of the embodiments in the specification is described in a progressive manner. Each of the embodiments focuses on the differences from other embodiments, and a same or similar part among the embodiments may refer to each other.

Finally, it should be noted that, in the present disclosure, relational terms such as first and second are used only to distinguish one entity or operation from another entity or operation, without necessarily requiring or implying any such actual relationship or order between these entities or operations. Moreover, the term “include”, “comprise” or any other variation thereof is intended to cover non-exclusive inclusions, so that a process, method, commodity or equipment not only includes those elements, but also includes other elements that are not explicitly listed, or includes elements inherent in the process, method, commodity or equipment. In the absence of further restrictions, the element limited by statement “include one . . . ” does not exclude the existence of other identical elements in the process, method, commodity or equipment including the element.

An OLED pixel driving circuit, a driving method and a display device provided by the present disclosure are described in detail. In the present disclosure, the principle and implementation of the present disclosure are described with specific examples. The explanation of the above embodiment is only used to help understand the method and core idea of the present disclosure. For one of ordinary skills in the art, in accordance with the idea of the present disclosure, may have changes in specific implementation method and application scope. In summary, the contents of the specification should not be construed as restrictions on the present disclosure.

What is claimed is:

1. A pixel driving circuit for driving a light emitting device in a pixel, comprising a reset sub-circuit, a storage sub-circuit, a compensation sub-circuit, a data writing sub-circuit and a driving transistor; wherein
the reset sub-circuit is connected with a first voltage input terminal, a second voltage input terminal, a third voltage input terminal, a first node and a second node, and is configured to write a first voltage input from the first voltage input terminal to the first node, and write a second voltage input from the second voltage input terminal to the second node according to a third voltage input from the third voltage input terminal;
the storage sub-circuit is connected with the first node and the second node, and is configured to store a voltage on a control electrode of the driving transistor;
the compensation sub-circuit is connected with a fourth voltage input terminal, the second node and an anode of the light emitting device, and is configured to write a threshold voltage of the driving transistor to the second node according to a fourth voltage input from the fourth voltage input terminal;
the data writing sub-circuit is connected with a fifth voltage input terminal, a sixth voltage input terminal and the first node, and is configured to write a sixth voltage input from the sixth voltage input terminal to the first node according to a fifth voltage input from the fifth voltage input terminal; and
a control electrode of the driving transistor is connected with the second node, a first electrode of the driving transistor is connected with the first voltage input terminal, and a second electrode of the driving transistor is connected with the anode of the light emitting device, to drive the light emitting device to emit light according to a voltage of the second node.

2. The pixel driving circuit according to claim 1, wherein the reset circuit comprises a first transistor and a second transistor;
a control electrode of the first transistor is connected with the third voltage input terminal, a first electrode of the first transistor is connected with the first voltage input terminal, and a second electrode of the first transistor is connected with the first node;
a control electrode of the second transistor is connected with the third voltage input terminal, a first electrode of the second transistor is connected with the second voltage input terminal, and a second electrode of the second transistor is connected with the second node.

3. The pixel driving circuit according to claim 1, wherein the storage sub-circuit comprises a storage capacitor, a first end of the storage capacitor is connected with the first node, and a second end of the storage capacitor is connected with the second node.

4. The pixel driving circuit according to claim 1, wherein the compensation sub-circuit comprises a third transistor, a control electrode of the third transistor is connected with the fourth voltage input terminal, a first electrode of the third transistor is connected with the second node, and a second electrode of the third transistor is connected with the anode of the light emitting device.

5. The pixel driving circuit according to claim 1, wherein the data writing sub-circuit comprises a fourth transistor, a control electrode of the fourth transistor is connected with the fifth voltage input terminal, a first electrode of the fourth transistor is connected with the sixth voltage input terminal, and a second electrode of the fourth transistor is connected with the first node.

6. The pixel driving circuit according to claim 1, wherein the active layer of the driving transistor is made of amorphous silicon.

7. The pixel driving circuit according to claim 1, further comprising a fifth transistor, a control electrode of the fifth transistor is connected with the fourth voltage input terminal, a first electrode of the fifth transistor is connected with the first voltage input terminal, and a second electrode of the fifth transistor is connected with the first node.

8. The pixel driving circuit according to claim 1, wherein
the reset circuit comprises a first transistor and a second transistor, a control electrode of the first transistor is connected with the third voltage input terminal, a first electrode of the first transistor is connected with the first voltage input terminal, and a second electrode of the first transistor is connected with the first node; a control electrode of the second transistor is connected with the third voltage input terminal, a first electrode of the second transistor is connected with the second voltage input terminal, and a second electrode of the second transistor is connected with the second node;
the storage sub-circuit comprises a storage capacitor, a first end of the storage capacitor is connected with the first node, and a second end of the storage capacitor is connected with the second node;
the compensation sub-circuit comprises a third transistor, a control electrode of the third transistor is connected with the fourth voltage input terminal, a first electrode of the third transistor is connected with the second node, and a second electrode of the third transistor is connected with the anode of the light emitting device;
the data writing sub-circuit comprises a fourth transistor, a control electrode of the fourth transistor is connected with the fifth voltage input terminal, a first electrode of the fourth transistor is connected with the sixth voltage input terminal, and a second electrode of the fourth transistor is connected with the first node; and
the pixel driving circuit further comprises a fifth transistor, a control electrode of the fifth transistor is connected with the fourth voltage input terminal, a first electrode of the fifth transistor is connected with the first voltage input terminal, and a second electrode of the fifth transistor is connected with the first node.

9. A display device comprising the pixel driving circuit of claim 1.

10. A pixel driving method applied to the pixel driving circuit of claim 1, comprising:
in a reset stage, writing the first voltage to the first node, and writing the second voltage to the second node according to the third voltage; wherein the first voltage input terminal is supplied with the first voltage, the second voltage input terminal is supplied with the second voltage, and the third voltage input terminal is supplied with the third voltage;
in a compensation stage, writing the threshold voltage of the driving transistor to the second node according to the fourth voltage, wherein the fourth voltage input terminal is supplied with the fourth voltage; and
in a light-emitting stage, writing the sixth voltage to the first node according to the fifth voltage, and driving the light emitting device to emit light according to the voltage of the second node, wherein the fifth voltage input terminal is supplied with the fifth voltage, the sixth voltage input terminal is supplied with the sixth voltage.

11. The pixel driving method according to claim 10, wherein,
in the reset stage, the first voltage is low level, the second voltage is high level, and the sixth voltage is low level;
in the compensation stage, the first voltage is low level, the second voltage is high level, and the sixth voltage is low level; and
in the light-emitting stage, the first voltage is high level, the second voltage is low level, and the sixth voltage is high level.

12. The pixel driving method according to claim 10, wherein the transistors in the reset sub-circuit, the compensation sub-circuit, and the data writing sub-circuit and the driving transistor are all N-type transistors,
in the reset stage, the third voltage is high level, the fourth voltage is low level, and the fifth voltage is low level;
in the compensation stage, the third voltage is low level, the fourth voltage is high level, and the fifth voltage is low level;
in the light-emitting stage, the third voltage is low level, the fourth voltage is low level, and the fifth voltage is high level.

13. The pixel driving method according to claim 11, wherein the transistors in the reset sub-circuit, the compensation sub-circuit, and the data writing sub-circuit and the driving transistor are all N-type transistors,
in the reset stage, the third voltage is high level, the fourth voltage is low level, and the fifth voltage is low level;
in the compensation stage, the third voltage is low level, the fourth voltage is high level, and the fifth voltage is low level;
in the light-emitting stage, the third voltage is low level, the fourth voltage is low level, and the fifth voltage is high level.
